(19) United States
(12) Patent Application Publication
(10) Pub. No.: US 2025/0077223 A1
(43) Pub. Date: Mar. 6, 2025

(54) IN-SERVICE UPGRADE OF PROGRAM CODE FILES

(71) Applicant: HEWLETT PACKARD ENTERPRISE DEVELOPMENT LP, Spring, TX (US)

(72) Inventors: Vivek Palagrahara Shyamasundar, Roseville, CA (US); Robert Adam Nebeker, Sacramento, CA (US)

(21) Appl. No.: 18/456,841

(22) Filed: Aug. 28, 2023

(51) Int. Cl. G06F 8/656; G06F 8/61; G06F 40/194

(52) U.S. Cl. CPC G06F 8/656; G06F 8/63; G06F 40/194

(57) ABSTRACT

In some examples, an electronic device receives a program image including program code files arranged in a file system, and the electronic device mounts, in the electronic device, the file system including the program code files of the program image. The electronic device identifies a first program code file in the mounted file system that is modified with respect to an installed program code file in the electronic device. The electronic device performs an in-service upgrade of the installed program code file in the electronic device with the first program code file from the program image during a live operation of the electronic device.

### BACKGROUND

An electronic device can execute programs (including machine-readable instructions) to perform tasks of the electronic device. Some programs can be run on a central processing unit (CPU) of the electronic device. Other programs may be run on other electronic components of the electronic device.

### BRIEF DESCRIPTION OF THE DRAWINGS

Some implementations of the present disclosure are described with respect to the following figures.

FIG. 1 is a block diagram of an arrangement that includes a deployment server and switches to which program images are to be deployed, in accordance with some examples.

FIG. 2 is a flow diagram of a process of deploying an updated program image to a switch, in accordance with some examples.

FIG. 3 is a block diagram of an upgrade root file system and a previously installed root file system, according to some examples.

FIG. 4 is a block diagram of an updated program image according to further examples.

FIG. 5 is a flow diagram of a process according to some examples.

FIG. 6 is a block diagram of an electronic device according to some examples.

FIG. 7 is a block diagram of a storage medium storing machine-readable instructions according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

After initial installation of programs in an electronic device, the programs may be upgraded with new versions of the programs. To deploy the new versions of the programs to the electronic device, a deployment server can send a program image including program patch updates to the electronic device. A program patch update refers to machine-readable instructions intended to update installed machine-readable instructions in the electronic device. In some cases, in addition to the program patch updates, the program image may also include a boot package used for booting the electronic device. The boot package includes the complete set of program code files that are to be used in booting the electronic device. The boot package can include both updated and non-updated program code files. The updated program code files in the boot package may be duplicative of the program patch updates in the program image. If there is a large quantity of program patch updates in the program image, then the program image would include a large quantity of duplicative program code files. The presence of the duplicate program code files increases the overall size of the program image. Sending a large program image over a network to a large number of electronic devices may overburden communication resources of the network, which can result in reduced communication bandwidth for other operations over the network. Additionally, a large program image can lead to increased usage of resources of each electronic device that receives the program image, including increased memory usage to store the program image and increased processing resource usage when processing the program image.

In accordance with some implementations of the present disclosure, a program image useable to upgrade programs of an electronic device includes a boot package of program code files useable to boot the electronic device. However, the program image excludes program patch updates. The boot package of program code files includes (1) updated program code files that are updated relative to corresponding program code files previously installed in the electronic device, and (2) non-updated program code files that are of the same versions as corresponding program code files previously installed in the electronic device. By excluding program patch updates from the program image, the program image does not include duplicate program code files. As a result, the total size of the program image is reduced as compared to a program image that includes both the boot package and program patch updates. In some implementations of the present disclosure, the program code files of the program image are arranged according to a file system, such as a root file system. Upon receiving a program image, an electronic device mounts the file system of the program image, and the electronic device retrieves the program code files of the program image from the mounted file system. The electronic device identifies any program code files that are modified relative to installed program code files in the electronic device. The electronic device then performs an in-service upgrade of installed program code files using the identified program code files.

An in-service upgrade of an installed program code file can be accomplished while the electronic device is performing live operations of the electronic device. A “live operation” of an electronic device refers to a target operation of the electronic device for which the electronic device was deployed, such as an operation of forwarding data packets of a switch, or executing application programs to provide a service, or any other type of operation. In other words, the in-service upgrade can be accomplished without interrupting the ability of the electronic device from performing target operations. The in-service upgrade of the installed program code file can also be performed without having to reboot the electronic device. After the installed program code file has been replaced with an updated program code file, the machine-readable instructions can be loaded onto a corresponding processing circuitry of the electronic device for execution without first having to reboot the electronic device.

A “program image” refers to information containing machine-readable instructions that can be installed in an electronic device. The machine-readable instructions can be in the form of program code files. A “program code file” can refer to a data structure that contains either machine language code (which can be executed directly by processing circuitry) or source code (which is compiled or interpreted into executable code for execution by processing circuitry). Multiple program code files in the program image can execute on processing circuitry to perform respective tasks. The processing circuitry can include a main processor, also referred to as a central processing unit (CPU), of the electronic device. Additionally or alternatively, the processing circuitry can include other processing components of the electronic, such as any or some combination of the following: a graphics processing unit (GPU), a microcontroller, an input/output (IO) device, a programmable integrated circuit device, a programmable gate array, or any other type of circuitry capable of executing machine-readable instructions.

“Updated program code files” in a program image are modified relative to installed program code files in an electronic device. The updated program code files may be new versions or older versions of the installed program code files. An “installed program code file” refers to a program code file that is deployed in the electronic device and is ready to execute when invoked. “Non-updated program code files” in a program image are not modified relative to installed program code files in the electronic device.

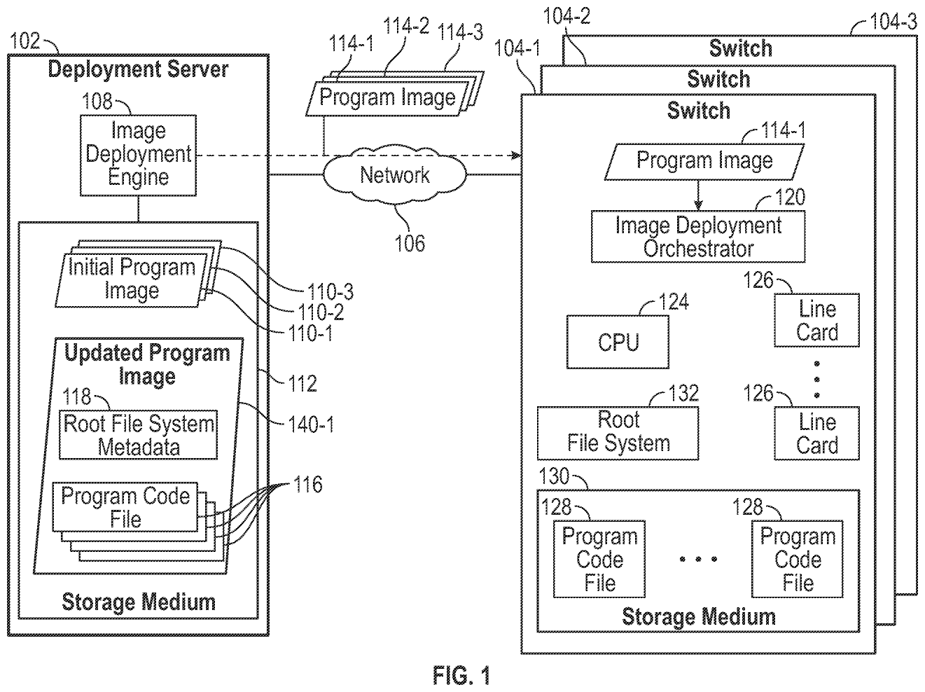

FIG. 1 is a block diagram of an example arrangement that includes a deployment server 102 and switches 104-1, 104-2, and 104-3. Although FIG. 1 shows an example with three switches, in other examples, a different quantity of switches may be present. The switches 104-1, 104-2, and 104-3 may be part of a network environment to communicate data between source devices and destination devices. A “switch” refers to a communication node that is able to forward data packets based on network addresses in the data packets. A switch is a layer 2 communication node to forward data packets based on layer 2 network addresses, such as Media Access Control (MAC) addresses. Layer 2 refers to a data link layer that is part of the Open Systems Interconnection (OSI) model, for example. In other examples, techniques or mechanisms according to some implementations of the present disclosure can be applied to upgrade program code files in other types of communication nodes, such as layer 3 routers that route data packets based on Internet Protocol (IP) addresses in data packets.

Although FIG. 1 shows switches, in other examples, an arrangement can include different types of electronic devices to which the deployment server 102 can send program images for upgrading program code files.

The deployment server 102 can be implemented as a collection of computers (a single computer or multiple computers). The deployment server 102 is able to send, over a network 106, program images 114-1, 114-2, and 114-3 to respective switches 104-1, 104-2, and 104-3. More specifically, the program image 114-1 is sent to the switch 104-1, the program image 114-2 is sent to the switch 104-2, and the program image 114-3 is sent to the switch 104-3. The network 106 can include a local area network (LAN), a wide area network (WAN), a public network such as the Internet, or other types of communication media.

The deployment server 102 includes an image deployment engine 108 that is able to retrieve any of various program images 110-1, 110-2, 110-3, and 140-1 for transmission to a respective switch over the network 106. The program images 110-1, 110-2, 110-3, and 140-1 are stored on a storage medium 112. The program image 114-1 received by the switch 104-1 from the deployment server 102 can either be the program image 110-1 (an initial program image) or the program image 140-1 (an updated program image). Initial and updated program images are discussed further below.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

The storage medium 112 can be implemented using one or more storage devices, such as disk-based storage devices, solid state drives, memory devices (e.g., dynamic random access memory (DRAM) devices, static random access memory (SRAM) devices, flash memory devices, or other types memory devices), or other devices that are able to store information.

In the ensuing discussion, reference is made to components and operations of the switch 104-1. The other switches 104-2 and 104-3 can include similar components and can have similar operations.

The switch 104-1 includes an image deployment orchestrator 120 that manages the installation of program code files in the switch 104-1. More specifically, the image deployment orchestrator 120 receives the program image 114-1 from the deployment server 102 over the network 106, and the image deployment orchestrator 120 installs one or more selected program code files in the program image 114-1 in the switch 104-1.

The image deployment orchestrator 120 can be implemented as hardware processing circuitry, or alternatively, as machine-readable instructions executable on hardware processing circuitry of the switch 104-1, such as a CPU 124 in the switch 104-1. The CPU 124 is able to execute further machine-readable instructions of the switch 104-1, such as machine-readable instructions to manage the forwarding of data packets over a network (e.g., the network 106 or another network), an operating system (OS), firmware, and/or other machine-readable instructions.

The switch 104-1 further includes other processing circuitry to execute machine-readable instructions, including one or more line cards 126, which are I/O devices. A “line card” refers to a module of the switch 104-1 that includes one or more ports and communication components to support communication of data packets over a network. In further examples, the switch 104-1 can include additional or alternative processing circuitry for executing machine-readable instructions.

In examples according to FIG. 1, the program images 110-1 to 110-3 are initial program images used to deploy program code files to the respective switches 104-1 to 104-3. The program image 140-1 is an updated program image that includes one or more program code files that are updated relative to corresponding one or more program code files in the initial program image 110-1. Note that although FIG. 1 shows that both the initial program image 110-1 and the updated program image 140-1 are present on the storage medium 112, in actual operation the updated program image 140-1 may replace the initial program image 110-1, which may be removed after storage of the initial program image 110-1 on the storage medium 112.

Although not shown in FIG. 1, there may be additional updated program images that contain updated program code files relative to program code files in the initial program images 110-2 and 110-3. More generally, an “initial” program image can refer to a program image that is provided earlier in time than an “updated” program image. Note that the “initial” program image may itself be updated relative to a prior program image.

In an example, when the switch 104-1 is initially added to the network environment, the switch 104-1 can include just hardware and possibly a minimal set of machine-readable instructions, such as firmware, for starting up basic functionalities of the switch 104-1. Initially, certain program code files (such as those containing machine-readable instructions executable on the CPU 124 and the line cards 126) may not yet be installed in the switch 104-1. The deployment server can send the initial program image 110-1 to the switch 104-1 to perform initial setup that includes installing the program code files in the switch 104-1. At this point, the program image 114-1 received by the image deployment orchestrator 120 from the deployment server 102 is the initial program image 110-1.

After the installation of the program code files of the initial program image 110-1 to the switch 104-1, the switch 104-1 includes installed program code files 128 stored in a storage medium 130 of the switch 104-1. The installation of the program code files 128 based on the initial program image 110-1 also installs a root file system 132 that manages the storage of the program code files at 128 on the storage medium 130. A root file system refers to a file system that is generally small in size, with a relatively smaller quantity of files as compared to file systems associated with OSes that store user and program data. In examples according to FIG. 1, the root file system 132 is to organize the program code files 128 on the storage medium 130.

In some examples, the initial program image 110-1 includes root file system metadata that defines the root file system 132. The root filesystem metadata includes information indicating a type or format of the root file system. The type or format information of the root file system indicates to the initial boot code of the switch a mechanism to be used for processing, unpacking, and installing the root file system.

The program code files 128 are accessible via the root file system 132 used for deploying machine-readable instructions of the program code files 128 to processing circuitry (e.g., the CPU 124 and the line cards 126) of the switch 104-1. For example, after the program code files 128 and the root file system 132 are installed in the switch 104-1, the image deployment orchestrator 120 or a different entity in the switch 104-1 can retrieve the machine-readable instructions of the program code files 128 for installation onto the CPU 124 and the line cards 126.

In other examples, instead of using a root file system, a different type of file system can be used to organize the program code files 128 on the storage medium 130.

After the initial deployment of the program code files 128, a new version of one or more of the program code files 128 may become available. The deployment server 102 can receive the updated program image 140-1 that contains a collection of program code files 116, including both updated program code files and non-updated program code files. An updated program code file in the updated program image 140-1 is modified relative to a program code file 128 installed in the switch 104-1. The updated program image 140-1 further includes root file system metadata 118.

In accordance with some examples of the present disclosure, the updated program image 140-1 does not include any program patch updates. Rather, the collection of program code files 116 makes up a boot package that includes a complete set of program code files used for booting the switch 104-1.

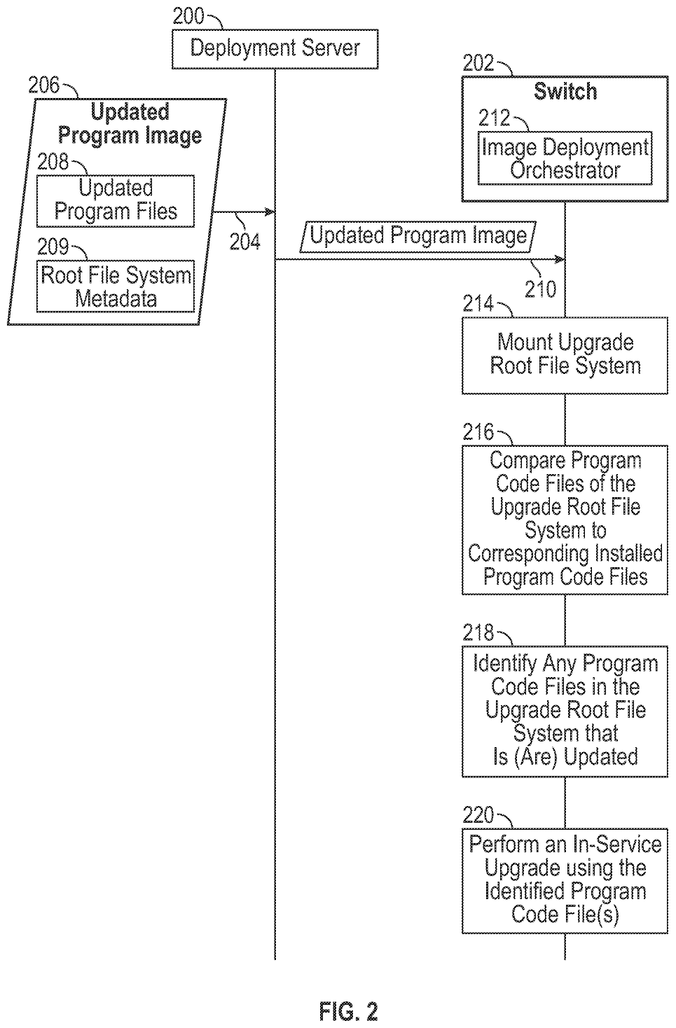

FIG. 2 is a flow diagram of a program file update process that involves a deployment server 200 and a switch 202. An example of the deployment server 200 is the deployment server 102 of FIG. 1, and an example of the switch 202 is any of the switches 104-1 to 104-3 of FIG. 1.

The deployment server 200 receives (at 204) an updated program image 206 that includes updated program files 208 (and possibly non-updated program files assuming that some of the installed program files in the switch 202 have not been updated). The updated program image 206 further includes file system metadata 209. An example of the updated program image 206 is the updated program image 140-1 of FIG. 1.

In some examples, the root file system defined by the file system metadata 2090 is a squashfs, which is a file system that compresses files and directories. Using squashfs allows the program code files of the updated program image 206 to be compressed, which reduces the size of the updated program image 206. In other examples, squashfs is not employed and the program code files in the updated program image 206 are not compressed.

The updated program image 206 may have been created by an entity (e.g., a human, a program, or a machine), in response to the entity receiving notification of the availability of any updated program files. After creating the updated program image 206, the entity provides the updated program image 206 to the deployment server 200.

The deployment server 200 sends (at 210) the updated program image 206 to the switch 202 over a network, such as the network 106 of FIG. 1. Upon receiving the updated program image 206, an image deployment orchestrator 212 in the switch 202 mounts (at 214) a root file system based on the file system metadata 209 in the updated program image 206. An example of the image deployment orchestrator 212 is the image deployment orchestrator 120 of FIG. 1.

Mounting the root file system in the switch 202 refers to making the root file system accessible in the switch 202. The root file system that is mounted based on the updated program image 206 is referred to as an “upgrade root file system” in the present discussion. The upgrade root file system mounted based on the updated program image 206 is distinguished from a previously installed root file system, such as the root file system 132 mounted based on the initial program image 110-1 in FIG. 1. More generally, a file system mounted based on the updated program image 206 is referred to as an “upgrade file system,” which is different from a previously installed file system (installed prior to receipt of the updated program image 206 by the switch 202).

The upgrade root file system is mounted to a particular point of a file system hierarchy of the switch 202. The file system hierarchy of the switch 202 can include various directories. The upgrade root file system can be attached to a first directory in the file system hierarchy of the switch 202. The previously mounted root file system may be attached to a second directory in the file system hierarchy of the switch 202.

Once the upgrade root file system of the updated program image 206 is mounted in the switch 202, the image deployment orchestrator 212 can compare (at 216) the program code files of the upgrade root file system to corresponding installed program code files of the previously installed root file system. The comparison performed by the image deployment orchestrator 212 can be a comparison of the content of program code files in the upgrade root file system to content of installed program code files in the previously installed root file system. A difference between the content of a program code file in the upgrade root file system and the content of a corresponding installed program code file in the previously installed root file system indicates that the program code file in the upgrade root file system is updated relative to the corresponding installed program code file in the previously installed root file system. Alternatively, the comparison performed by the image deployment orchestrator 212 can be a comparison of signatures associated with the program code files in the upgrade root file system with signatures of corresponding installed program code file in the previously installed root file system. A “signature” of a program code file include a hash of the content of the program code file (based on applying a hash function on the content of the program code file), a checksum calculated from the content of the program code file, or any other type of value that can be derived from the entirety or a portion of the program code file.

In other examples, the updated program image 206 may include information (such as in the form of a manifest) that identifies which program code files in the updated program image 206 are updated (and possibly identifies which program code files in the updated program image 206 are not updated). In such examples, the image deployment orchestrator 212 does not perform the comparison (at 216), but rather can use the manifest or other information to identify which program code files in the updated program image 206 are updated.

Based on the comparison or based on the manifest or other information in the updated program image 206, the image deployment orchestrator 212 identifies (at 218) any program code files in the upgrade root file system that is (are) updated relative to corresponding installed program code file in the previously installed root file system. The image deployment orchestrator 212 then performs (at 220) an in-service upgrade using the identified program code file(s) of the upgrade root file system. The in-service upgrade can include removing an out-of-date installed program code file in the previously installed root file system and replacing the removed out-of-date installed program code file with an identified program code file from the upgrade root file system.

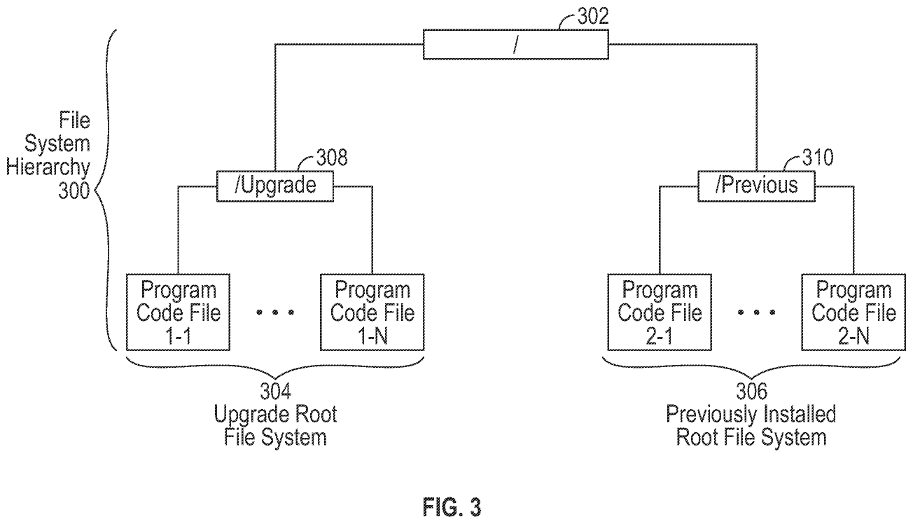

FIG. 3 shows an example of an upgrade root file system 304 and a previously installed root file system 306 mounted in a file system hierarchy 300 of a switch, such as any of the switches 104-1 to 104-3 of FIG. 1 or the switch 202 of FIG. 2. An example of the previously installed root file system 306 is the root file system 132 of FIG. 1.

The file system hierarchy 300 includes a root directory 302 to which can be attached further directories. In the example of FIG. 3, the upgrade root file system 304 is mounted in the file system hierarchy 300 by attaching a root 308 (represented as “/upgrade”) of the upgrade root file system 304 as a first directory under to the root directory 302. Similarly, the previously installed root file system 306 is mounted in the file system hierarchy 300 by attaching a root 310 (represented as “/previous”) of the upgrade root file system 306 as a second directory under to the root directory 302.

Program code files 1-1 to 1-N(N>2) of the upgrade root file system 304 are located in the/upgrade directory 308, and corresponding installed program code files 2-1 to 2-N of the previously installed root file system 306 are located in the/previous directory 310. The program code files 1-1 to 1-N are accessible by retrieving them from the/upgrade directory 308, and the installed program code files 2-1 to 2-N are accessible by retrieving them from the/previous directory 310.

Note that each of the upgrade root file system 304 and the previously installed root file system 306 may include subdirectories containing program code files (not shown in FIG. 3). The directory structure of the upgrade root file system 304 is the same as the directory structure of the previously installed root file system 306. In other words, the program code files of the upgrade root file system 304 have similar paths from the/upgrade directory 308 as the program code files the previously installed root file system 306 from the/previous directory 310.

When performing the comparison (at 216) in FIG. 2, the image deployment orchestrator traverses the directory paths of each of the upgrade root file system 304 and the previously installed root file system 306 and retrieves corresponding program code files for comparison. The image deployment orchestrator compares program code file 1 in the upgrade root file system 304 to program code file A in the previously installed root file system 306, compares program code file 2 in the upgrade root file system 304 to program code file B in the previously installed root file system 306, and similarly compares other program code files of the upgrade root file system 304 and the previously installed root file system 306.

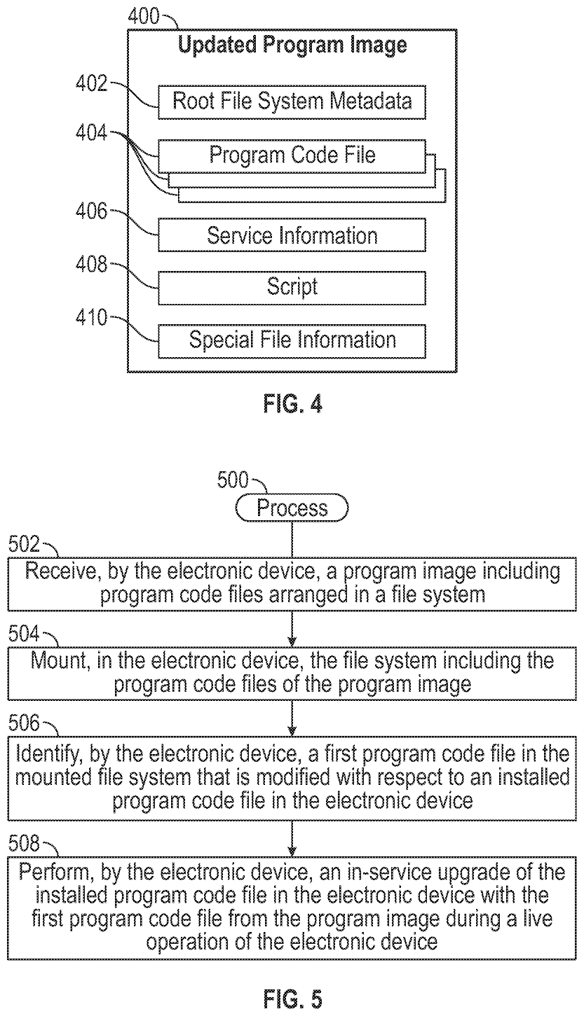

FIG. 4 is a block diagram of an updated program image 400 according to further examples. The updated program image 400 is an example of the updated program image 140-1 of FIG. 1, or the updated program image 206 of FIG. 2. The updated program image 400 includes root file system metadata 402 and program code files 404 (including updated and non-updated program code files).

The updated program image 400 further includes service information 406, a script 408, and special file information 410. The service information 406 identifies a service in a switch to be restarted after an updated program code file is installed from the updated program image 400. A “service” can refer to any process or thread executed due to execution of a program in the switch. The service that is restarted is a service that makes use of the updated program code file. Restarting the service allows the restarted service to use the machine-readable instructions of the updated program code file rather than the machine-readable instructions of the out-of-date program code file that was replaced.

The service information 406 can identify multiple services to be restarted after respective updated program code files are installed from the updated program image 400. Examples of services of the switch that can be restarted include any or some combination of the following: a fan management service to manage a fan in the switch; a slot/port management service to manage a slot or port of the switch; a protocol service to manage a virtual local area network (VLAN); or any other type of service.

The script 408 includes machine-readable instructions that are to be executed in the switch prior to installing an updated program code file from the updated program image 400. The script 408 may perform any or some combination of the following: deactivate or activate a port of a switch; update a register in the switch; or any other action that is a prerequisite to installing the updated program code file. There may be multiple scripts in the updated program image 400.

The special file information 410 specifies how one or more special files are to be handled as part of upgrading program code files. Examples of special files include any or some combination of the following: a configuration file that is used to adjust a setting in a switch; a hardware description file that describes a structure or behavior hardware circuitry; or any other type of file.

An image deployment orchestrator can restart one or more services based on the service information 406, execute the script 408, and handle special files according to the special file information 410.

In further examples, the root file system metadata 402 can define multiple root file systems (e.g., multiple squashfs file systems) that contain respective different collections of program code files. In such examples, when the image deployment orchestrator receives the updated program image 400, the image deployment orchestrator can mount just one of the root file systems, or alternatively, can mount the root file systems in sequence one at a time to check whether each root file system contains an updated program code file to install in a switch.

FIG. 5 is a block diagram of a process 500 according to some examples. The process 500 can be performed by an electronic device, such as any of the switches 104-1 to 104-3 or 202 in FIG. 1 or 2, or any other type of electronic device.

The process 500 includes receiving (at 502), by the electronic device, a program image including program code files arranged in a file system. Examples of the program image include any of 140-1 or 206 or 400 of FIG. 1, 2, or 4. The program image may received by the electronic device from a deployment server such as the deployment server 102 or 200 of FIG. 1 or 2.

The process 500 includes mounting (at 504), in the electronic device, the file system includes the program code files of the program image. “Mounting” the file system refers from the program image refers to extracting the program code files from the program image and making the program code files available at a point in a file system hierarchy in the electronic device.

The process 500 includes identifying (at 506), by the electronic device, a first program code file in the mounted file system that is modified with respect to an installed program code file in the electronic device. “Identifying” a program code file that is modified refers to making a determination that the program code file is different (either newer or older) than another program code file. Note that the “first program code file” identified as being modified can be any of the program code files of the mounted file system. The identifying that the program code file is modified can be based on comparing a program code file of the program image with an installed program code file that was previously installed in the electronic device. Alternatively, the identifying that the program code file is modified can be based on information in the program image that identifies which program code files are updated.

The process 500 includes performing (at 508), by the electronic device, an in-service upgrade of the installed program code file in the electronic device with the first program code file from the program image during a live operation of the electronic device. An “in-service upgrade” of a program code file refers to an upgrade that is performed while the electronic device continues to perform its target operations, and after the upgrade, the electronic device is not rebooted.

In some examples, the file system of the program image is an upgrade file system, and the installed program code file is stored in a previously installed file system previously mounted in the electronic device.

In some examples, the electronic device traverses the mounted upgrade file system and retrieves the program code files of the program image from the mounted upgrade file system. The electronic device compares the retrieved program code files of the program image to installed program code files in the previously installed file system. Based on the comparing, the electronic device identifies the first program code file that is modified.

In some examples, the mounting of the file system includes mounting the file system of the program image at a point in a file system hierarchy of the electronic device.

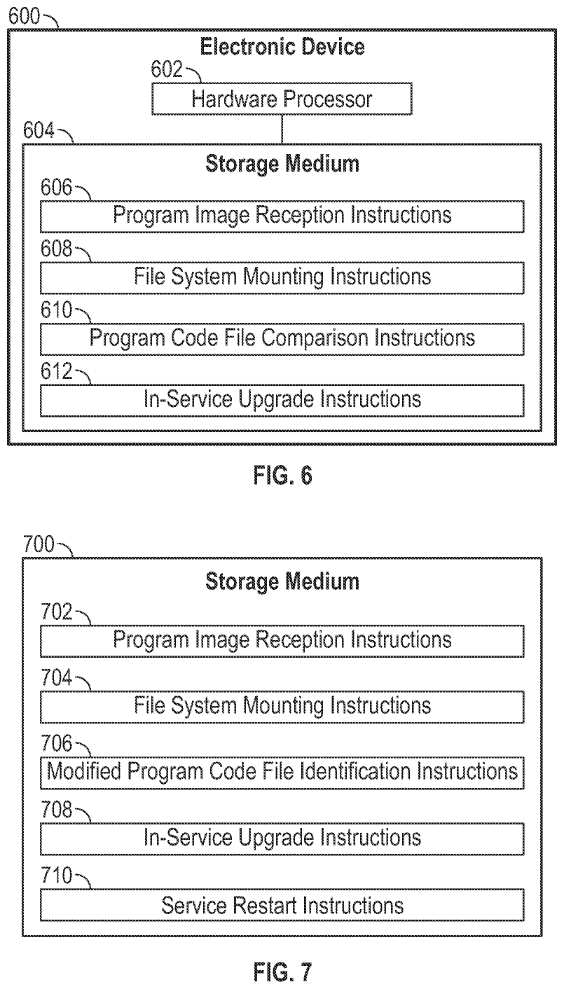

FIG. 6 is a block diagram of an electronic device 600 according to some examples. An example of the electronic device 600 is any of the switches 104-1 to 104-3 or 202 of FIG. 1 or 2.

The electronic device 600 includes a hardware processor 602 (or multiple hardware processors). A hardware processor can include a microprocessor, a core of a multi-core microprocessor, a microcontroller, a programmable integrated circuit, a programmable gate array, or another hardware processing circuit.

The electronic device 600 a storage medium 604 storing machine-readable instructions executable on the hardware processor 602 to perform various tasks. Machine-readable instructions executable on a hardware processor can refer to the instructions executable on a single hardware processor or the instructions executable on multiple hardware processors.

The machine-readable instructions include program image reception instructions 606 to receive a program image including program code files arranged in a file system. The program image can be an updated program image such as 140-1 or 206 or 400 in FIG. 1, 2, or 4.

The machine-readable instructions include file system mounting instructions 608 to mount the file system including the program code files of the program image in the electronic device. The file system of the program image can be mounted at a point in a file system hierarchy of the electronic device.

The machine-readable instructions include program code file comparison instructions 610 to compare a first program code file of the mounted file system to an installed program code file of a previously installed file system. “Comparing” the first program code file to the installed program code file can refer to comparing content of the first program code file to content of the installed program code file, or can refer to comparing a signature of the first program code file to a signature of the installed program code file.

The machine-readable instructions include in-service upgrade instructions 612 to, based on detecting that the first program code file of the mounted file system is updated relative to the installed program code file, perform an in-service upgrade of the installed program code file using the first program code file, such as by replacing the installed program code file with the first program code file.

FIG. 7 is a block diagram of a non-transitory machine-readable or computer-readable storage medium 700 storing machine-readable instructions that upon execution cause an electronic device to perform various tasks.

The machine-readable instructions of the storage medium 700 include program image reception instructions 702 to receive a program image including program code files arranged in a file system. The program code files in the program image form a complete set of program code files for booting the electronic device, and the program image further includes service information identifying a service of the electronic device.

The machine-readable instructions of the storage medium 700 include file system mounting instructions 704 to mount the file system including the program code files of the program image in the electronic device.

The machine-readable instructions of the storage medium 700 include modified program code file identification instructions 706 to identify a first program code file in the mounted file system that is modified with respect to an installed program code file in the electronic device.

The machine-readable instructions of the storage medium 700 include in-service upgrade instructions 708 to, based on the identifying, perform an in-service upgrade of the installed program code file using the first program code file.

The machine-readable instructions of the storage medium 700 include service restart instructions 710 to restart, based on the service information in the program image, the service to use machine-readable instructions of the first program code file in place of machine-readable instructions of the installed program code file. “Restarting” a service can refer to stopping or otherwise shutting down the service, and then triggering the service to start execution again.

A storage medium (e.g., 604 in FIG. 6 or 700 in FIG. 7) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by an electronic device, a program image comprising program code files arranged in a file system;
mounting, in the electronic device, the file system comprising the program code files of the program image;
identifying, by the electronic device, a first program code file in the mounted file system that is modified with respect to an installed program code file in the electronic device; and
performing, by the electronic device, an in-service upgrade of the installed program code file in the electronic device with the first program code file from the program image during a live operation of the electronic device.

2. The method of claim 1, wherein the identifying of the first program code file in the mounted file system that is modified with respect to the installed program code file in the electronic device comprises comparing the first program code file to the installed program code file stored in the electronic device.

3. The method of claim 1, wherein the file system of the program image is an upgrade file system, and wherein the installed program code file is stored in a previously installed file system previously mounted in the electronic device.

4. The method of claim 3, comprising:
traversing the mounted upgrade file system and retrieving the program code files of the program image from the mounted upgrade file system;
comparing the retrieved program code files of the program image to installed program code files in the previously installed file system; and
based on the comparing, identifying the first program code file that is modified.

5. The method of claim 1, wherein the mounting of the file system comprises mounting the file system of the program image at a point in a file system hierarchy of the electronic device.

6. The method of claim 1, wherein the in-service upgrade of the installed program code file is performed without rebooting the electronic device.

7. The method of claim 1, wherein the mounting of the file system comprises mounting a root file system comprising the program code files of the program image.

8. The method of claim 1, wherein the program image comprises service information identifying a service, the method comprising:
restarting, based on the service information in the program image, the service in the electronic device; and
executing the restarted service in the electronic device, the restarted service using machine-readable instructions of the first program code file instead of machine-readable instructions of the installed program code file.

9. The method of claim 1, wherein the program image comprises a script, the method comprising:
executing the script prior to performing the in-service upgrade of the installed program code file.

10. The method of claim 1, wherein the in-service upgrade of the installed program code file comprises replacing the installed program code file with the first program code file.

11. The method of claim 1, wherein the electronic device is a switch of a network, and the live operation comprises forwarding of data packets by the switch, and wherein the in-service upgrade of the installed program code file is performed while the switch forwards data packets.

12. The method of claim 1, wherein the program image is without any program patch updates.

13. The method of claim 1, wherein the program code files of the program image comprise a complete set of program code files for booting the electronic device.

14. An electronic device comprising:
a hardware processor; and
a storage medium comprising instructions executable on the hardware processor to:
receive a program image comprising program code files arranged in a file system;
mount the file system comprising the program code files of the program image in the electronic device;
compare a first program code file of the mounted file system to an installed program code file of a previously installed file system; and
based on detecting that the first program code file of the mounted file system is updated relative to the installed program code file, perform an in-service upgrade of the installed program code file using the first program code file.

15. The electronic device of claim 14, wherein the program image comprises service information identifying a service, and wherein the instructions are executable on the hardware processor to:
restart, based the service information in the program image, the service in the electronic device; and
execute the restarted service in the electronic device, the restarted service using machine-readable instructions of the first program code file instead of machine-readable instructions of the installed program code file.

16. The electronic device of claim 15, wherein the in-service upgrade of the installed program code file is performed without rebooting the electronic device.

17. The electronic device of claim 14, wherein the program image comprises a script, and wherein the instructions are executable on the hardware processor to:
execute the script prior to performing the in-service upgrade of the installed program code file.

18. The electronic device of claim 14, wherein the program image is without any program patch updates.

19. A non-transitory machine-readable storage medium comprising instructions that upon execution cause an electronic device to:
receive a program image comprising program code files arranged in a file system, wherein the program code files form a complete set of program code files for booting the electronic device, and wherein the program image further comprises service information identifying a service of the electronic device;
mount the file system comprising the program code files of the program image in the electronic device;
identify a first program code file in the mounted file system that is modified with respect to an installed program code file in the electronic device;
based on the identifying, perform an in-service upgrade of the installed program code file using the first program code file; and
restart, based on the service information in the program image, the service to use machine-readable instructions of the first program code file in place of machine-readable instructions of the installed program code file.

20. The non-transitory machine-readable storage medium of claim 19, wherein the identifying of the first program code file that is modified comprises:
comparing the first program code file of the mounted file system to the installed program code file of a previously installed file system, or
using information in the program image identifying which program code files are updated.
